(19) United States
(12) Patent Application Publication
(10) Pub. No.: US 2024/0061901 A1
(43) Pub. Date: Feb. 22, 2024

(54) COMPUTER-READABLE RECORDING MEDIUM STORING OUTPUT PROGRAM, OUTPUT METHOD, AND INFORMATION PROCESSING APPARATUS

(71) Applicant: Fujitsu Limited, Kawasaki-shi (JP)

(72) Inventors: Ken KOBAYASHI, Setagaya (JP); Yasunari HIKIMA, Kawasaki (JP); Yuhei UMEDA, Kawasaki (JP)

(73) Assignee: Fujitsu Limited, Kawasaki-shi (JP)

(21) Appl. No.: 18/343,359

(22) Filed: Jun. 28, 2023

(30) Foreign Application Priority Data
Aug. 17, 2022 (JP) 2022-130163

(51) Int. Cl. G06F 17/11

(52) U.S. Cl. CPC G06F 17/11

(57) ABSTRACT

A non-transitory computer-readable recording medium stores an output program for causing a computer to execute a process including: acquiring a plurality of solutions over a Pareto front; fitting a Bezier simplex to the plurality of solutions that has been acquired; calculating a gradient of the Bezier simplex at a plurality of data points over the Bezier simplex that has been fit; and for each of the plurality of data points that has been generated, outputting evaluation information on robustness of a solution corresponding to the data point based on the gradient that has been calculated.

### CROSS-REFERENCE TO RELATED APPLICATION

This application is based upon and claims the benefit of priority of the prior Japanese Patent Application No. 2022-130163, filed on Aug. 17, 2022, the entire contents of which are incorporated herein by reference.

### FIELD

The embodiment discussed herein is related to a computer-readable recording medium storing an output program, an output method, and an information processing apparatus.

### BACKGROUND

Heretofore, in the field of designing an aircraft, an engine, or the like, there has been a case where a design value is selected based on solutions (design candidates) obtained by solving a multi-objective optimization problem. A multi-objective optimization problem is a problem in which a plurality of objective functions is simultaneously optimized, and there is a plurality of optimal solutions that gives an appropriate trade-off relationship between the objective functions. For this reason, in a case where a design value is selected from solutions obtained by solving a multi-objective optimization problem, it is a goal to obtain an optimal trade-off curve (Pareto front) obtained when a plurality of solutions are plotted in a multidimensional space.

Bezier Simplex Fitting: Describing Pareto Fronts of Simplicial Problems with Small Samples in Multi-Objective Optimization, Internet <URL: https://www.aaai.org/ojs/index.php/AAAI/article/view/4069> is disclosed as related art.

### SUMMARY

According to an aspect of the embodiments, a non-transitory computer-readable recording medium stores an output program for causing a computer to execute a process including: acquiring a plurality of solutions over a Pareto front; fitting a Bezier simplex to the plurality of solutions that has been acquired; calculating a gradient of the Bezier simplex at a plurality of data points over the Bezier simplex that has been fit; and for each of the plurality of data points that has been generated, outputting evaluation information on robustness of a solution corresponding to the data point based on the gradient that has been calculated.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram for explaining selection of a design candidate (solution) from a result of multi-objective optimization;

FIG. 2 is an explanatory diagram for explaining a problem in a case where the Pareto front is not visualized;

FIG. 3 is a block diagram illustrating an example of a functional configuration of an information processing apparatus according to an embodiment;

FIG. 4 is an explanatory diagram for explaining an example of input information;

FIG. 5 is an explanatory diagram for explaining that the Pareto front is simplicial;

FIG. 6 is an explanatory diagram for explaining an example of a Bezier simplex;

FIG. 7 is an explanatory diagram for explaining fitting of a Bezier simplex to the Pareto front;

FIG. 8 is an explanatory diagram for explaining an example of fitting of a Bezier simplex;

FIG. 9 is an explanatory diagram for explaining an example of generation of data points;

FIG. 10 is an explanatory diagram for explaining an example of display and output;

FIG. 11 is an explanatory diagram for explaining an example of a visualized image;

FIG. 12 is an explanatory diagram for explaining an example of a visualized image;

FIG. 13 is a flowchart illustrating an example of the operation of the information processing apparatus according to the embodiment; and

FIG. 14 is an explanatory diagram for explaining an example of the configuration of a computer.

### DESCRIPTION OF EMBODIMENTS

However, in a case where there are a large number of objective functions, data (solutions) are sparsely distributed due to the curse of dimensionality. In such a case where solutions are sparsely distributed, it is difficult to determine the robustness against a change in value due to noise or the like only by plotting a plurality of solutions over the Pareto front. For this reason, there is a problem that it is difficult to select a solution that is robust against noise.

According to one aspect, it is an object to provide an output program, an output method, and an information processing apparatus that may support selection of an appropriate solution.

An output program, an output method, and an information processing apparatus according to an embodiment will be described below with reference to the drawings. In the embodiment, configurations having the same function are denoted by the same reference sign, and redundant description thereof is omitted. The output program, output method, and information processing apparatus to be described in the embodiment below are merely examples, and do not limit the embodiment. Portions of the embodiment below may be appropriately combined as long as the portions of the embodiment do not contradict each other.

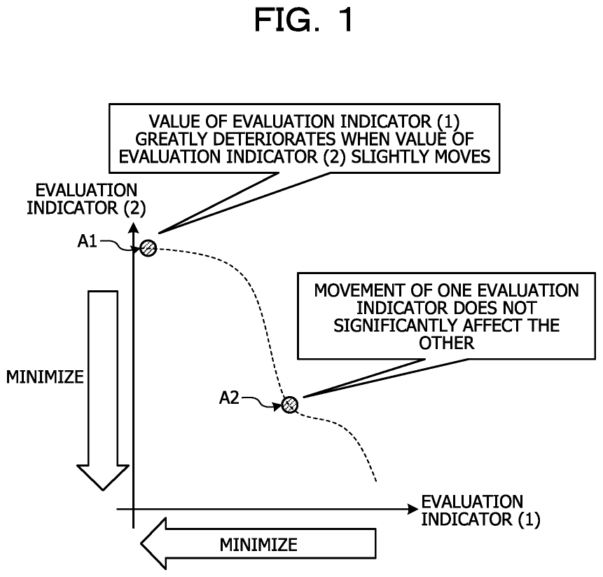

FIG. 1 is an explanatory diagram for explaining selection of a design candidate (solution) from a result of multi-objective optimization. As illustrated in FIG. 1, in the field of design, a user selects a desired solution from solutions A1 and A2 (design candidates) over the Pareto front (dotted line in the drawing) obtained by solving a multi-objective optimization problem, and selects the solution as a design value. In the illustrated example, solutions A1 and A2 are obtained by solving an optimization problem of two objective functions related to evaluation indicator (1) and evaluation indicator (2).

In the selection of a solution, since noise may be included in evaluation indicator (1) and evaluation indicator (2), there is a request from the user that the user desires to select a solution that is robust against the noise.

For example, solution A1 is a solution that is not much robust against noise since the value of evaluation indicator (1) greatly deteriorates when the value of evaluation indicator (2) slightly moves. By contrast, solution A2 is a solution that is robust against noise since slight movement of one evaluation indicator does not significantly affect the other evaluation indicator.

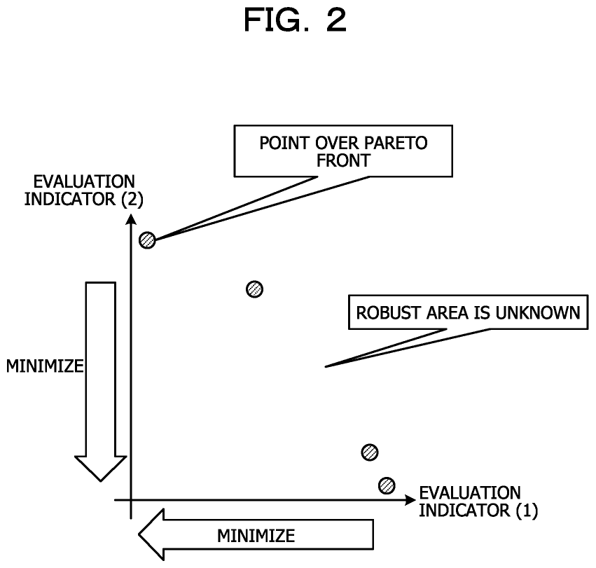

FIG. 2 is an explanatory diagram for explaining a problem in a case where the Pareto front is not visualized. As illustrated in FIG. 2, in a case where there are a large number of objective functions, data (solutions) are sparsely distributed due to the curse of dimensionality. For this reason, in a diagram in which solutions are simply plotted and visualized, it is difficult to know how much one evaluation indicator is affected by the movement of the other evaluation indicator, and it is difficult to evaluate the robustness of a solution.

In the information processing apparatus according to the embodiment, a Bezier simplex is fit to a plurality of solutions over the Pareto front, and a plurality of data points is generated over the Bezier simplex. Next, in the information processing apparatus according to the embodiment, a gradient of the Bezier simplex at the generated plurality of data points is calculated, and for each of the plurality of generated data points, evaluation information on the robustness of a solution corresponding to the data point based on the calculated gradient is output. Accordingly, in the information processing apparatus according to the embodiment, the robustness of a solution may be easily determined and selection of an appropriate solution may be supported.

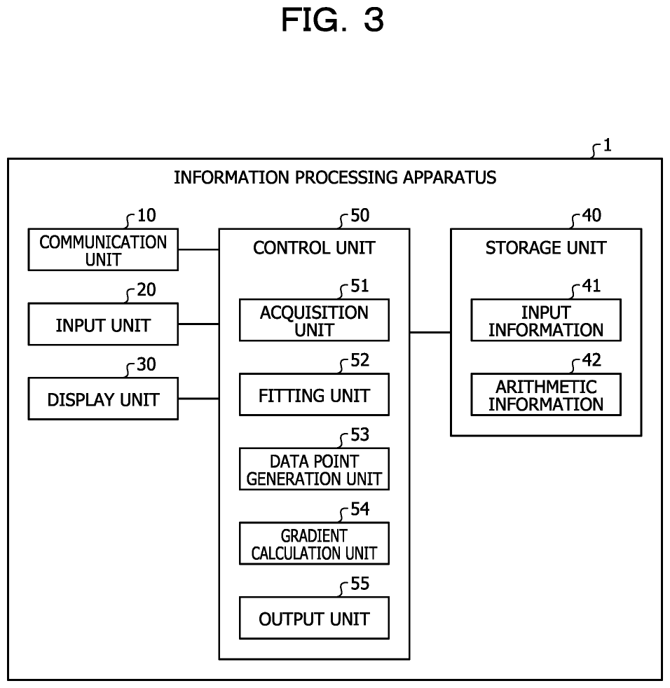

FIG. 3 is a block diagram illustrating an example of a functional configuration of the information processing apparatus according to the embodiment. As illustrated in FIG. 3, an information processing apparatus 1 includes a communication unit 10, an input unit 20, a display unit 30, a storage unit 40, and a control unit 50. For example, a personal computer (PC) or the like may be applied as the information processing apparatus 1.

The communication unit 10 receives various types of data from an external device via a network. The communication unit 10 is an example of a communication device. For example, the communication unit 10 may receive a part or all of input information 41 to be described later from the external device.

The input unit 20 is an input device that inputs various types of information to the control unit 50 of the information processing apparatus 1. The input unit 20 corresponds to a keyboard, a mouse, a touch panel, or the like. For example, the input unit 20 receives a part or all of the input information 41 to be described later by an input operation from a user.

The display unit 30 is a display device that displays information output from the control unit 50. For example, the display unit 30 displays a processing result or the like in the information processing apparatus 1.

The storage unit 40 stores the input information 41 and arithmetic information 42. The storage unit 40 corresponds to a semiconductor memory element such as a random-access memory (RAM) or a flash memory, or a storage device such as a hard disk drive (HDD).

The input information 41 is information related to input to the information processing apparatus 1. For example, the input information 41 includes a plurality of solutions over the Pareto front, which is a calculation result of a multi-objective optimization problem.

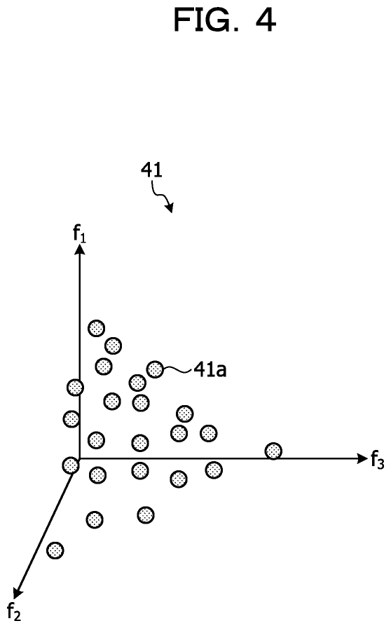

FIG. 4 is an explanatory diagram for explaining an example of the input information 41. As illustrated in FIG. 4, the input information 41 includes a plurality of solutions 41a over the Pareto front obtained by solving the optimization problem of three objective functions (evaluation indicators) of f₁, f₂, and f₃.

For example, in a case of a two-objective optimization problem related to the shape of a main wing of an aircraft, the evaluation indicators include an aerodynamic drag coefficient, a structural weight, and the like. In a case of a three-objective optimization problem related to environmental emissions of a diesel engine, the evaluation indicators include nitrogen oxide (NOx), specific fuel consumption (SFC), and soot (Soot).

The arithmetic information 42 is various types of data obtained by arithmetic processing of the information processing apparatus 1. For example, the arithmetic information 42 includes results obtained by processing of a fitting unit 52, a data point generation unit 53, a gradient calculation unit 54, and the like based on the input information 41. For example, the arithmetic information 42 includes a Bezier simplex, a plurality of data points over the Bezier simplex, gradient information indicating a gradient of the Bezier simplex, and the like (details will be described later).

The control unit 50 includes an acquisition unit 51, the fitting unit 52, the data point generation unit 53, the gradient calculation unit 54, and an output unit 55. The control unit 50 is implemented by a central processing unit (CPU), a graphics processing unit (GPU), a hard wired logic such as an application-specific integrated circuit (ASIC) or a field-programmable gate array (FPGA), and the like.

The acquisition unit 51 is a processing unit that acquires a plurality of solutions over the Pareto front obtained by solving a multi-objective optimization problem to be analyzed, the solutions being input via the communication unit 10 or the input unit 20. For example, the plurality of solutions over the Pareto front are obtained by applying a multi-objective optimization algorithm such as a genetic algorithm. The acquisition unit 51 stores information (coordinate values or the like) of the acquired plurality of solutions over the Pareto front in the storage unit 40 as the input information 41.

The fitting unit 52 is a processing unit that fits a Bezier simplex to the plurality of solutions over the Pareto front acquired by the acquisition unit 51. A Bezier simplex means a Bezier curve defined by using a plurality of control points and generalized to a high dimension.

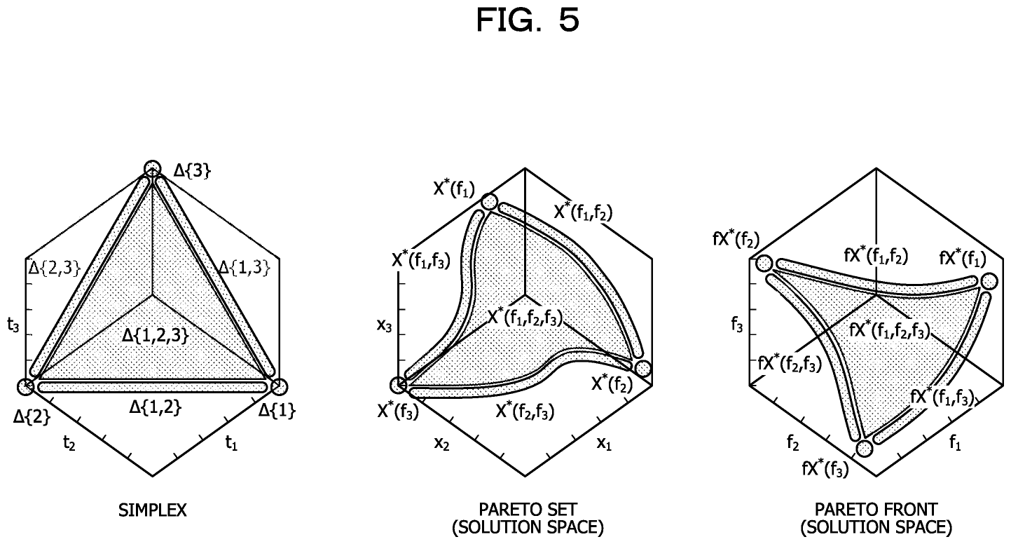

The Pareto front appearing in reality is often simplicial. FIG. 5 is an explanatory diagram for explaining that the Pareto front is simplicial.

As illustrated in FIG. 5, the Pareto front may be represented by a simplex of a curved “(number of objective functions)−1”-dimensional triangle. In this case, some of the solutions of a problem of optimizing objective functions correspond to the vertices, edges, surface, . . . of a triangle. It is known that such a simplicial multi-objective optimization problem frequently occurs in various fields such as design of an airplane or a diesel engine, a facility arrangement problem, a pure exchange economy, and a water circulation model.

Therefore, by using a Bezier simplex, the fitting unit 52 may perform fitting to a plurality of solutions over the Pareto front, taking into account the boundary of the solutions corresponding to the above vertices, edges, surface, . . . of a triangle. For example, the fitting unit 52 performs fitting by using an (M−1)-dimensional Bezier simplex of degree D defined by the following formula (1).

$$b ( t ) := {\sum }_{d ∈ {ℕ}_{D}^{M}} ( \begin{matrix}D \\ d\end{matrix} ) {t}^{d} {p}_{d} ( t ∈ {Δ}^{M - 1} ) \qquad ( 1 )$$

In formula (1), b(t) corresponds to a Bezier simplex (mapping). t is a parameter of an M-dimensional real vector. (D d) is a multinomial coefficient. T^{d} is a monomial (multiple index) of degree D. P_{d} is a control point of the M-dimensional real vector. Δ^{M-1} represents an (M−1)-dimensional simplex. The number of control points of a Bezier simplex is determined by the degree D and the dimension M.

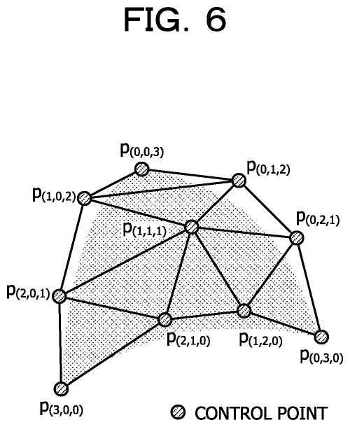

FIG. 6 is an explanatory diagram for explaining an example of a Bezier simplex. As illustrated in FIG. 6, a Bezier simplex of a shaded portion is defined by a plurality of control points (p). The number of control points (p) of this Bezier simplex is determined by the degree (D) and the dimension (M).

The illustrated example illustrates a Bezier simplex in which D=3 and M=3. Indices of each control point p(i, j, k) (a circle in FIG. 6) are each an integer of 0 or more, and satisfy i+j+k=D=3. For example, p(3, 0, 0), p(0, 3, 0), and p(0, 0, 3) are control points corresponding to the vertices of a triangle indicating a Bezier simplex, respectively. In fitting of the Bezier simplex in the illustrated example, estimation is performed such that the control points respectively match the solutions obtained by optimizing the first, second, and third objective functions.

For example, the fitting unit 52 estimates the coordinates (vector values) indicating each control point by an inductive skeleton estimation method. The inductive skeleton estimation method is a method of estimation in order from a control point that defines a low-dimensional simplex (skeleton), and the number of control points to be adjusted at one time does not depend on the number of objective functions. For this reason, in the inductive skeleton estimation method, the number of control points to be adjusted at one time may be reduced even in approximation of a high-dimensional simplex.

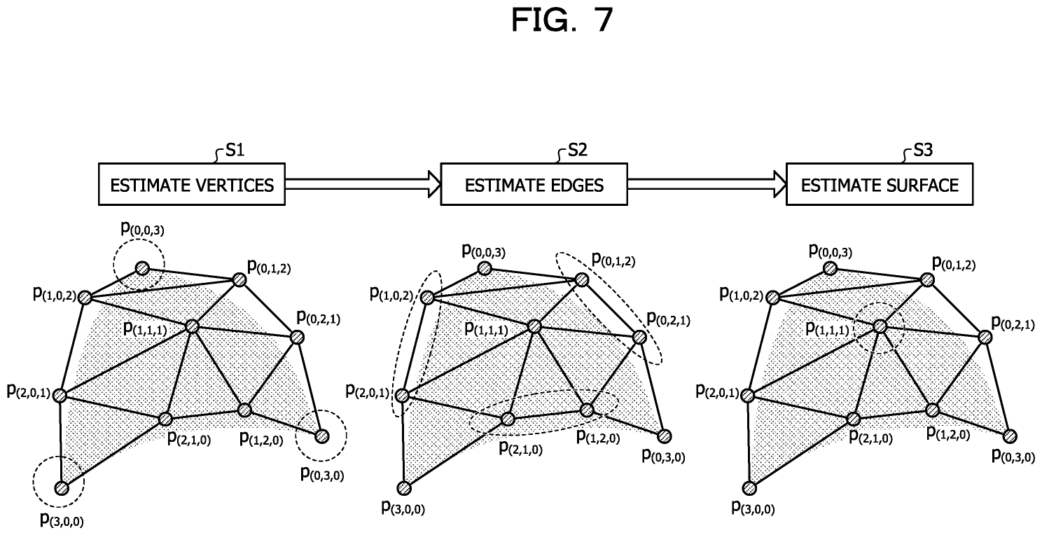

FIG. 7 is an explanatory diagram for explaining fitting of a Bezier simplex to the Pareto front. As illustrated in FIG. 7, the fitting unit 52 first estimates the vertices (S1). For example, the fitting unit 52 performs estimation such that p(3, 0, 0) matches the solution obtained by optimizing the first objective function, p(0, 3, 0) matches the solution obtained by optimizing the second objective function, and p(0, 0, 3) matches the solution obtained by optimizing the third objective function.

Next, the fitting unit 52 estimates the edges (S2). For example, the fitting unit 52 estimates the control points that define the shape of the edges of a triangle (dotted line portions of S2) in a state in which the control points p(3, 0, 0), p(0, 3, 0), and p(0, 0, 3) indicating the vertices of the triangle are fixed.

Next, the fitting unit 52 estimates the surface (S3). For example, the fitting unit 52 estimates the control point that defines the shape of the surface of the triangle (dotted line portion of S3) in a state in which the control points corresponding to the vertices and edges of the triangle are fixed.

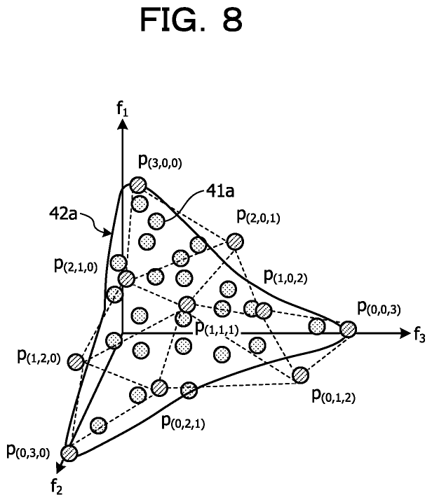

FIG. 8 is an explanatory diagram for explaining an example of fitting of a Bezier simplex. As illustrated in FIG. 8, the fitting unit 52 fits a Bezier simplex 42a by estimating each control point (p) based on the plurality of solutions 41a over the Pareto front. Next, the fitting unit 52 stores information indicating the Bezier simplex 42a fitted by such estimation (coordinate values of a plurality of control points or the like) in the arithmetic information 42.

The data point generation unit 53 is a processing unit that generates a plurality of data points over the Bezier simplex 42a fitted by the fitting unit 52.

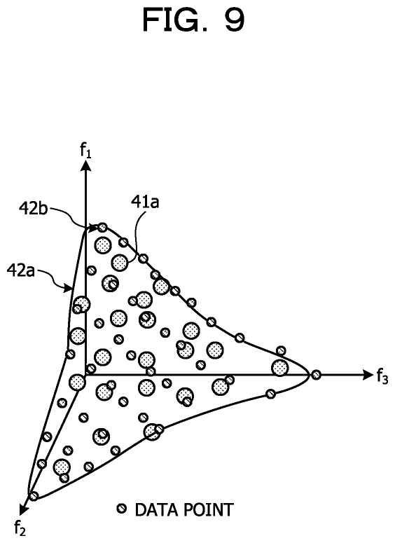

FIG. 9 is an explanatory diagram for explaining an example of generation of data points. As illustrated in FIG. 9, the data point generation unit 53 generates a plurality of data points 42b in a grid form over the Bezier simplex 42a defined by the plurality of control points (p). The data point generation unit 53 stores information related to the generated data points 42b (for example, coordinate values) in the arithmetic information 42.

An interval between the data points 42b generated in a grid form may be set in advance by a user. As described above, the information processing apparatus 1 may supplement sparse solutions by generating the plurality of data points 42b over the Bezier simplex 42a fitted to the plurality of solutions 41a over the Pareto front.

The gradient calculation unit 54 is a processing unit that calculates a gradient of the Bezier simplex 42a at the plurality of data points 42b generated by the data point generation unit 53. For example, the gradient calculation unit 54 calculates a gradient (length of gradient vector) of the Bezier simplex 42a by calculating all derivatives of the Bezier simplex 42a, and obtains the gradient at each of the plurality of data points 42b. The gradient calculation unit 54 stores information indicating the gradient at each of the plurality of data points 42b (length of gradient vector) in the arithmetic information 42.

The definition of the M-dimensional Bezier simplex 42a of degree D is as in the following formula (2).

$$b ( t ) = {\sum }_{d ∈ {ℕ}_{D}^{M}} ( \begin{matrix}D \\ d\end{matrix} ) {t}_{1}^{{d}_{1}} {t}_{2}^{{d}_{2}} … {t}_{m}^{{d}_{m}} … {t}_{M}^{{d}_{M}} \qquad ( 2 )$$

A gradient vector obtained by partial differentiation with parameter tₘ is as in the following formula (3).

$$\frac{db ( t )}{{dt}_{m}} = {\sum }_{d ∈ {ℕ}_{D}^{M}} ( \begin{matrix}D \\ d\end{matrix} ) {d}_{m} {t}_{1}^{{d}_{1}} {t}_{2}^{{d}_{2}} … {t}_{m}^{{d}_{m - 1}} … {t}_{M}^{{d}_{M}} \qquad ( 3 )$$

By using these formulae (2) and (3), all derivatives of the Bezier simplex 42a with parameter t=(t₁, t₂, . . . , t_{M}) are calculated as in the following formula (4).

$$db ( t ) = {\sum }_{m = 1}^{M} {t}_{m} \frac{db ( t )}{{dt}_{m}} \qquad ( 4 )$$

The output unit 55 is a processing unit that, for each of the plurality of data points 42b generated by the data point generation unit 53, outputs evaluation information on the robustness of a solution corresponding to the data point 42b based on the gradient calculated by the gradient calculation unit 54.

The magnitude of a gradient of the Bezier simplex 42a fitted to the Pareto front indicates the robustness against a change in value due to noise or the like. As an example, a change in value due to noise or the like is large at the data point 42b where the gradient of the Bezier simplex 42a is large, and the solution 41a in the vicinity of that data point 42b is a solution with low robustness. Conversely, a change in value due to noise or the like is small at the data point 42b where the gradient of the Bezier simplex 42a is small, and the solution 41a in the vicinity of that data point 42b is a solution with high robustness.

For example, for the plurality of data points 42b, the output unit 55 enumerates and outputs, as evaluation information, the values (magnitude of gradient) corresponding to the gradients (length of gradient vector) of the Bezier simplex 42a. The output unit 55 may generate a visualized image in which the plurality of data points 42b is plotted in an objective function space, and display and output each of the plurality of data points 42b on the display unit 30 in a display mode corresponding to the evaluation information.

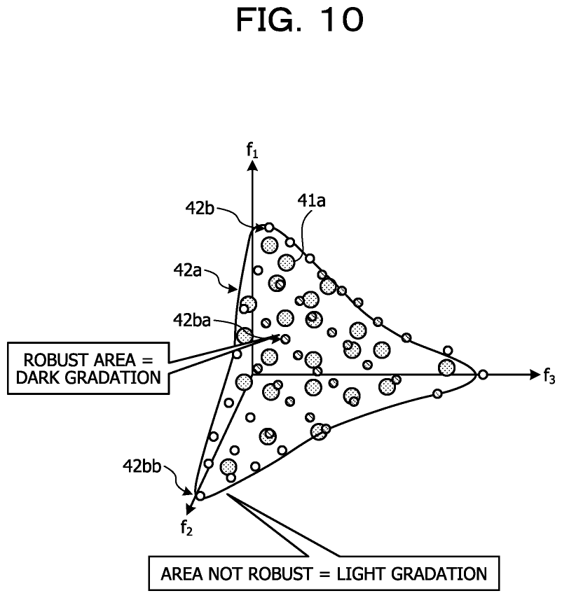

FIG. 10 is an explanatory diagram for explaining an example of display and output. As illustrated in FIG. 10, the output unit 55 visualizes the objective function space in which the Bezier simplex 42a is fitted to the points (solutions 41a) over the Pareto front, and displays and outputs the objective function space.

For example, the output unit 55 generates the Bezier simplex 42a and a visualized image in which the plurality of data points 42b in the arithmetic information 42 is plotted, in a two-dimensional space or a three-dimensional space corresponding to two or three objective functions selected from four or more objective functions (evaluation indicators). Next, the output unit 55 displays and outputs the plurality of data points 42b generated over the Bezier simplex 42a in a display mode corresponding to the magnitude of the gradient calculated by the gradient calculation unit 54.

For example, the output unit 55 displays data points 42ba having a gradient smaller than a predetermined threshold value and included in an area robust to noise (change in value) with a dark gradation. The output unit 55 displays data points 42bb having a gradient larger than the predetermined threshold value and included in an area not robust to noise (change in value) with a light gradation.

Accordingly, a user may easily check the robustness of the solution 41a from the display mode of the data point 42b in the vicinity of the solution 41a.

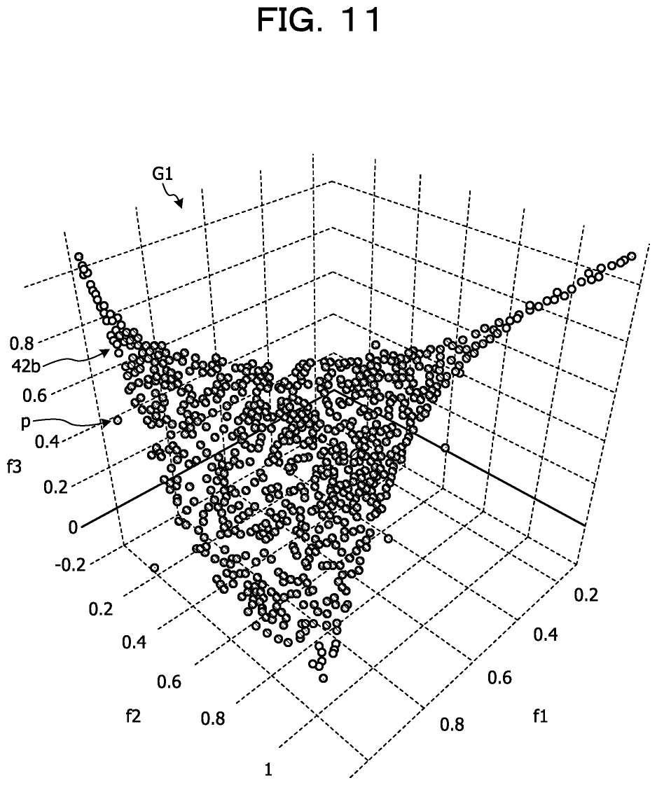

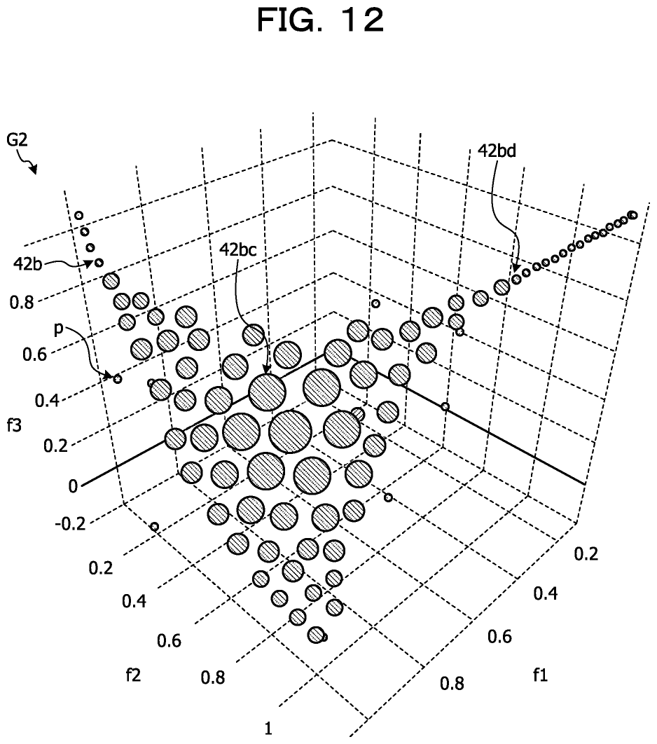

FIG. 11 and FIG. 12 are explanatory diagrams for explaining examples of a visualized image. As illustrated in FIG. 11, in a visualized image G1 in the objective function space of the three evaluation indicators (f1, f2, and f3), whether a solution is robust (strength of robustness) to noise (change in value) may be displayed by the gradation of the data point 42b. For example, when the gradient is smaller than the predetermined threshold value and the robustness is strong, the output unit 55 displays the data point 42b to be dark. When the gradient is larger than the predetermined threshold value and the robustness is weak, the output unit 55 displays the data point 42b to be light.

As illustrated in FIG. 12, in a visualized image G2 in the objective function space of the three evaluation indicators (f1, f2, and f3), whether a solution is robust (strength of robustness) to noise (change in value) may be displayed by the size of the data point 42b. For example, when the gradient is smaller than the predetermined threshold value and the robustness is strong, the output unit 55 displays the data point 42b to be large. When the gradient is larger than the predetermined threshold value and the robustness is weak, the output unit 55 displays the data point 42b to be small.

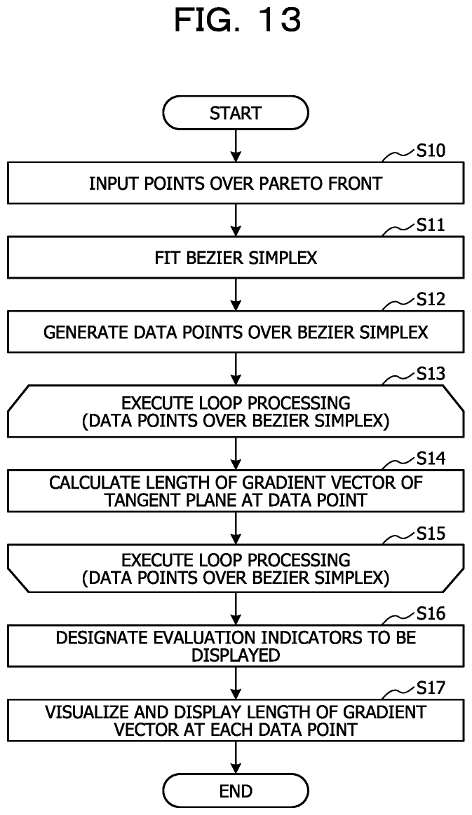

Next, details of the operation of the information processing apparatus 1 will be described. FIG. 13 is a flowchart illustrating an example of the operation of the information processing apparatus 1 according to the embodiment.

As illustrated in FIG. 13, when processing is started, the acquisition unit 51 receives input of the points (plurality of solutions 41a) over the Pareto front obtained by solving the multi-objective optimization problem to be analyzed (S10).

Next, the fitting unit 52 fits the Bezier simplex 42a to the points over the Pareto front acquired by the acquisition unit 51 (S11). Next, the data point generation unit 53 generates the plurality of data points 42b over the Bezier simplex 42a in a grid form (S12).

Next, the gradient calculation unit 54 executes loop processing for each of the data points 42b over the Bezier simplex 42a generated by the data point generation unit 53 (S13 to S15). For example, the gradient calculation unit 54 calculates all derivatives of the Bezier simplex 42a, and calculates a length of gradient vector of a tangent plane at the data point 42b (S14).

Next, the output unit 55 receives designation of evaluation indicators to be displayed among a large number of objective functions (evaluation indicators) through operation input by the input unit 20 or the like (S16). In the designation of evaluation indicators, the output unit 55 receives designation of two evaluation indicators in the case of two-dimensional visualization and receives designation of three evaluation indicators in the case of three-dimensional visualization.

Next, the output unit 55 generates the Bezier simplex 42a and a visualized image in which the plurality of data points 42b in the arithmetic information 42 is plotted, in a two-dimensional or three-dimensional space of the designated evaluation indicators. Next, the output unit 55 visualizes, displays, and outputs the length of gradient vector at each data point 42b over the Bezier simplex 42a, for example, the evaluation information (S17), and ends the processing.

As described above, the information processing apparatus 1 acquires a plurality of solutions over the Pareto front. The information processing apparatus 1 fits the Bezier simplex 42a to the acquired plurality of solutions. The information processing apparatus 1 generates the plurality of data points 42b over the fitted Bezier simplex 42a. The information processing apparatus 1 calculates a gradient of the Bezier simplex 42a at the generated plurality of data points 42b. For each of the plurality of generated data points 42b, the information processing apparatus 1 outputs evaluation information on the robustness of a solution corresponding to the data point 42b based on the calculated gradient. Accordingly, a user of the information processing apparatus 1 may easily determine the robustness of a solution based on the output evaluation information. As described above, the information processing apparatus 1 may support a user's selection of an appropriate solution.

In the visualized image G1 in which the plurality of data points 42b is plotted, the information processing apparatus 1 displays and outputs each of the plurality of data points 42b in a display mode corresponding to the evaluation information. Accordingly, a user of the information processing apparatus 1 may easily check the robustness of a solution corresponding to the data point 42b based on the display mode of the data point 42b plotted in the visualized image G1.

The information processing apparatus 1 displays and outputs the strength of the robustness of a solution corresponding to the evaluation information in a display mode of the gradation of the data point 42b or the size of the data point 42b. Accordingly, a user of the information processing apparatus 1 may easily check the robustness of a solution corresponding to the data point 42b based on the gradation of the data point 42b or the size of the data point 42b.

Each constituent element of each apparatus illustrated in the drawings does not have to be physically configured as illustrated in the drawings. For example, the specific form of the distribution and integration of each apparatus is not limited to the illustrated form, and all or a part of the apparatus may be configured in arbitrary units in a functionally or physically distributed or integrated manner depending on various kinds of loads, usage statuses, and the like.

All or some (arbitrary) of the various processing functions of the acquisition unit 51, the fitting unit 52, the data point generation unit 53, the gradient calculation unit 54, and the output unit 55, to be executed in the control unit 50 of the information processing apparatus 1, may be executed in a CPU (or a microcomputer, such as a microprocessor unit (MPU) or a microcontroller unit (MCU)). It goes without saying that all or some (arbitrary) of the various processing functions may be executed in a program analyzed and executed by a CPU (or a microcomputer, such as an MPU or MCU) or in hardware by wired logic. The various processing functions executed in the information processing apparatus 1 may be executed by cloud computing in which a plurality of computers collaborates with each other.

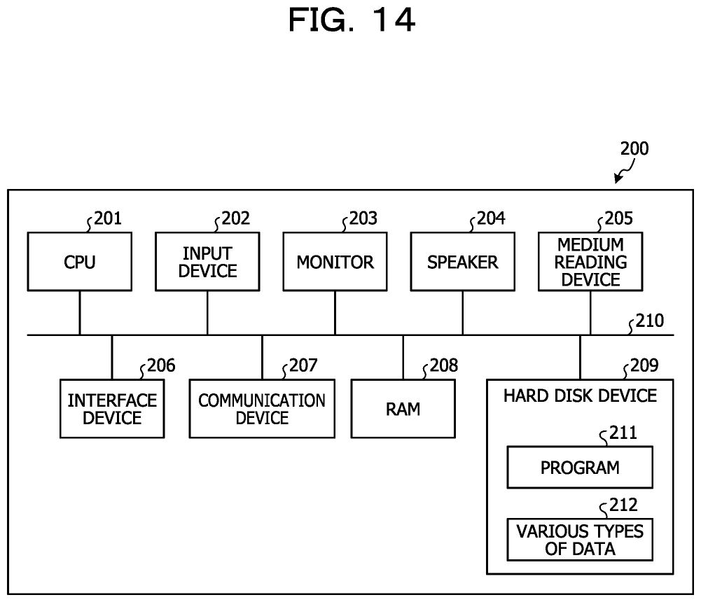

The various types of processing described in the above embodiment may be implemented by a computer executing a program prepared in advance. Hereinafter, an example of a (hardware) configuration of a computer that executes a program having the functions similar to those of the above embodiment will be described. FIG. 14 is an explanatory diagram for explaining an example of the configuration of a computer.

As illustrated in FIG. 14, a computer 200 includes a CPU 201 that executes various types of arithmetic processing, an input device 202 that receives data input, a monitor 203, and a speaker 204. The computer 200 includes a medium reading device 205 that reads a program or the like from a storage medium, an interface device 206 for coupling to various devices, and a communication device 207 for communication with and coupling to an external device in a wired or wireless manner. The computer 200 includes a RAM 208 that temporarily stores various types of information, and a hard disk device 209. The components (201 to 209) in the computer 200 are coupled to a bus 210.

A program 211 for executing various types of processing in the functional configuration described in the above embodiment (for example, the acquisition unit 51, the fitting unit 52, the data point generation unit 53, the gradient calculation unit 54, and the output unit 55) is stored in the hard disk device 209. The hard disk device 209 stores various types of data 212 to be referred to by the program 211. For example, the input device 202 receives input of operation information from an operator. For example, the monitor 203 displays various screens to be operated by an operator. For example, a printer or the like is coupled to the interface device 206. The communication device 207 is coupled to a communication network such as a local area network (LAN), and exchanges various types of information with an external device via the communication network.

The CPU 201 performs various types of processing related to the above functional configuration (for example, the acquisition unit 51, the fitting unit 52, the data point generation unit 53, the gradient calculation unit 54, and the output unit 55) by reading the program 211 stored in the hard disk device 209, loading the program to the RAM 208, and executing the program. The program 211 does not have to be stored in the hard disk device 209. For example, the program 211 stored in a storage medium readable by the computer 200 may be read and executed. For example, the storage medium readable by the computer 200 corresponds to a portable-type recording medium such as a compact disc read-only memory (CD-ROM), a Digital Versatile Disc (DVD), or a Universal Serial Bus (USB) memory, a semiconductor memory such as a flash memory, a hard disk drive, or the like. The program 211 may be stored in a device coupled to a public network, the Internet, a LAN, or the like, and the computer 200 may read and execute the program 211 from the device.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an output program for causing a computer to execute a process comprising:
acquiring a plurality of solutions over a Pareto front;
fitting a Bezier simplex to the plurality of solutions that has been acquired;
calculating a gradient of the Bezier simplex at a plurality of data points over the Bezier simplex that has been fit; and
for each of the plurality of data points that has been generated, outputting evaluation information on robustness of a solution corresponding to the data point based on the gradient that has been calculated.

2. The non-transitory computer-readable recording medium according to claim 1, wherein in the outputting, each of the plurality of data points is displayed and output in a display mode corresponding to the evaluation information in a visualized image in which the plurality of data points is plotted.

3. The non-transitory computer-readable recording medium according to claim 2, wherein in the outputting, strength of robustness of a solution corresponding to the evaluation information is displayed and output in a display mode of gradation of the data points or a size of the data points.

4. An output method comprising:
acquiring a plurality of solutions over a Pareto front;
fitting a Bezier simplex to the plurality of solutions that has been acquired;
calculating a gradient of the Bezier simplex at a plurality of data points over the Bezier simplex that has been fit; and
for each of the plurality of data points that has been generated, outputting evaluation information on robustness of a solution corresponding to the data point based on the gradient that has been calculated.

5. The output method according to claim 4, wherein in the outputting, each of the plurality of data points is displayed and output in a display mode corresponding to the evaluation information in a visualized image in which the plurality of data points is plotted.

6. The output method according to claim 5, wherein in the outputting, strength of robustness of a solution corresponding to the evaluation information is displayed and output in a display mode of gradation of the data points or a size of the data points.

7. An information processing apparatus comprising:
acquire a plurality of solutions over a Pareto front;
fit a Bezier simplex to the plurality of solutions that has been acquired;
calculate a gradient of the Bezier simplex at a plurality of data points over the Bezier simplex that has been fit; and
for each of the plurality of data points that has been generated, output evaluation information on robustness of a solution corresponding to the data point based on the gradient that has been calculated.

8. The information processing apparatus according to claim 7, wherein each of the plurality of data points is displayed and output in a display mode corresponding to the evaluation information in a visualized image in which the plurality of data points is plotted.

9. The information processing apparatus according to claim 8, wherein strength of robustness of a solution corresponding to the evaluation information is displayed and output in a display mode of gradation of the data points or a size of the data points.
